(19) United States
(12) Patent Application Publication
(10) Pub. No.: US 2016/0195221 A1
(43) Pub. Date: Jul. 7, 2016

(54) Autogas Dispensing Tank

(71) Applicant: James C. Roberts, Wills Point, TX (US)

(72) Inventor: James C. Roberts, Wills Point, TX (US)

(21) Appl. No.: 14/591,741

(22) Filed: Jan. 7, 2015

(51) Int. Cl. F17C 7/02; F17C 1/00

(52) U.S. Cl. CPC F17C 7/02; F17C 1/00; F17C 2205/0352; F17C 2221/035; F17C 2227/04; F17C 2260/02

(57) ABSTRACT

According to one embodiment, a liquid dispensing system includes a pressure chamber comprising a liquid space and a vapor space, and a liquid dispenser. A first and second orifice located in a bottom portion wall of the pressure chamber and each coupled to a vapor conduit extending into the vapor space of the pressure chamber form passageways between the first and second orifice and the vapor space. A third orifice of equal to or greater than approximately two inches diameter is located in the bottom portion wall of the pressure chamber. The third orifice is coupled to a liquid supply inlet port of the liquid dispenser; the second orifice is coupled to a liquid bypass port of the liquid supply pipe; and the first orifice is coupled to a vapor release port of the liquid dispenser.

### TECHNICAL FIELD

This disclosure generally relates to liquid storage tanks, and more particularly to autogas dispensing tanks.

### BACKGROUND

Propane autogas is a widely used alternative transportation fuel. Operators of autogas powered vehicles refuel using autogas dispensing systems found at service stations, truck stops, fleet-maintenance facilities, and propane sales outlets.

A conventional autogas dispensing system includes a liquid storage tank for storing fuel and a dispenser unit for transferring the fuel to a vehicle. Conventional autogas dispensing systems use standard above ground propane tanks for storing liquid propane.

A standard above ground tank's bottom portion (the liquid space) includes one 1.25 inch liquid opening for dispensing propane. A standard above ground tank's top portion (the vapor space) includes one 1.25 inch vapor opening and one 1.25 inch liquid withdrawal opening. The liquid withdrawal opening is attached to a diptube that extends towards the bottom of the tank in direct communication with the liquid space of the propane tank. Propane supply companies typically use the liquid withdrawal opening to empty the liquid propane before transporting a tank. When filling a propane tank, a propane supplier typically connects a vapor recovery hose from the supply truck to the vapor opening of the propane tank. When installed as part of an autogas dispensing system, the liquid opening, the vapor opening, and the liquid withdrawal opening of a standard above ground propane tank are connected, directly or indirectly, to the dispenser unit.

### SUMMARY

According to one embodiment, a liquid dispensing system includes a liquid storage tank and a liquid dispenser configured to dispense liquid into an external storage tank. The liquid storage tank includes a pressure chamber comprising a liquid space located at a bottom interior portion of the pressure chamber and a vapor space located at a top interior portion of the pressure chamber. A first orifice located in a bottom portion wall of the pressure chamber and a first vapor conduit coupled to the first orifice and extending into the vapor space of the pressure chamber form a passageway between the first orifice and the vapor space of the pressure chamber. A second orifice located in the bottom portion wall of the pressure chamber and a second vapor conduit coupled to the second orifice and extending into the vapor space of the pressure chamber form a passageway between the second orifice and the vapor space of the pressure chamber. A third orifice of equal to or greater than approximately two inches diameter is located in the bottom portion wall of the pressure chamber. The third orifice is coupled, by a liquid supply pipe, to a liquid supply inlet port of the liquid dispenser; the second orifice is coupled to a liquid bypass port of the liquid supply pipe; and the first orifice is coupled to a vapor release port of the liquid dispenser.

Certain embodiments may provide one or more technical advantages. In some embodiments, a vapor return orifice and a liquid bypass orifice located on a liquid storage tank's underside are configured such that the piping connecting the tank to a dispenser may be routed underneath the tank where the piping is protected. Additionally, the piping installation connecting the tank to the dispenser may be simplified (e.g., fewer turns and connectors) based on the location of the vapor return orifice and liquid bypass orifice in relation to each other and to a liquid supply orifice.

In some embodiments, extending a vapor conduit from a liquid bypass orifice located on the underside of a liquid storage tank to the tank's vapor space allows bypass liquids to return to the vapor space of the tank. Returning bypass liquids to the vapor space produces less back pressure on a pump than returning bypass liquids to the liquid space.

Another advantage of some embodiments is that an approximately two inch liquid supply orifice supplies sufficient liquid to run a high capacity propane pump. The ability to use a high capacity propane pump decreases refueling time for autogas propane vehicles with large fuel tanks such as buses and trucks.

As a result, particular embodiments of the present disclosure may provide numerous technical advantages. Particular embodiments of the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1 is an example autogas dispensing system, in accordance with particular embodiments;

FIG. 2A is a cross-sectional side view of an autogas dispensing tank, in accordance with particular embodiments; and

FIG. 2B is a cross-sectional end view of an autogas dispensing tank, in accordance with particular embodiments.

### DETAILED DESCRIPTION

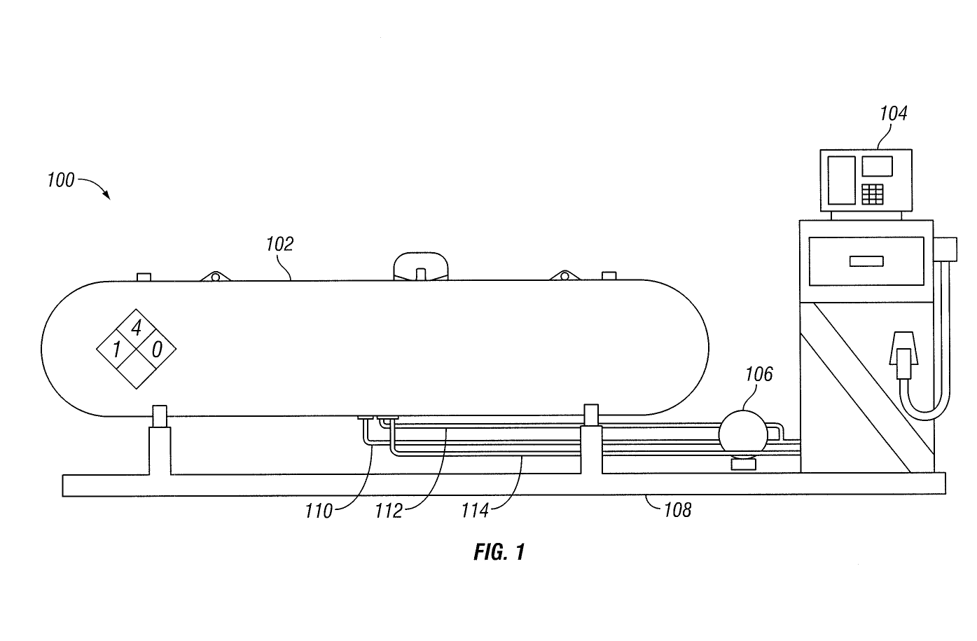

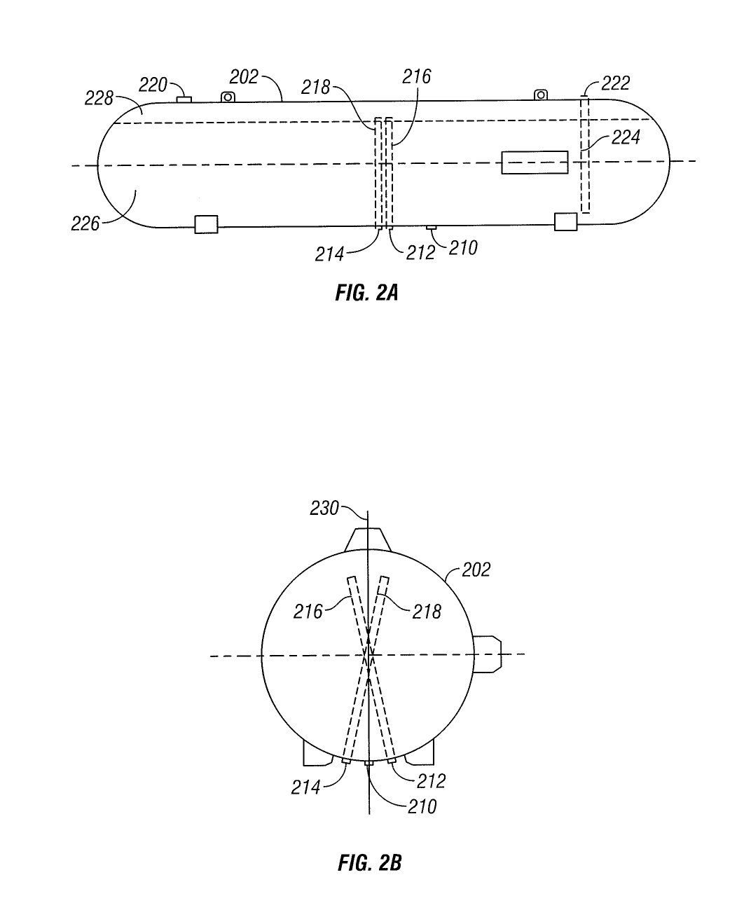

Particular embodiments and their advantages are best understood by reference to FIGS. 1, 2A, and 2B wherein like reference numbers indicate like features.

FIG. 1 is an example autogas dispensing system, in accordance with particular embodiments. FIG. 1 illustrates autogas dispensing system 100 comprising tank 102, dispenser 104, pump 106, and skid 108. In particular embodiments, autogas dispensing system 100 may dispense autogas propane for refueling autogas powered vehicles.

Tank 102 is a pressure chamber for storing liquid. Tank 102 may be constructed of any material suitable for containing the liquid commodity stored within. In particular embodiments, tank 102 may store autogas propane. The American Society of Mechanical Engineers (ASME), as well as national, state, and local agencies, publish rules and specifications for construction of propane tanks intended for use within the United States.

Dispenser 104 transfers a liquid stored in tank 102 to an external storage container, such as a vehicle fuel storage container. Dispenser 104 may comprise components for metering and displaying the amount of liquid dispensed. Dispenser 104 may comprise components for receiving and transmitting payment information. In particular embodiments, dispenser 104 may dispense autogas propane to autogas propane fueled vehicles.

Pump 106 pumps liquid from tank 102 to dispenser 104 through liquid supply pipe 110. The size and rating of pump 106 may be determined according to the pressure and volume requirements of dispenser 104. For example, a 2-hose dispenser 104 may require different pressure and volume than a 1-hose dispenser 104. In addition, the size of liquid supply pipe 110 determines, in part, the pressure and volume pump 106 is able to produce. In particular embodiments, pump 106 may be a turbine, gear, vane, or any suitable pump type for pumping the liquid commodity stored in tank 102. In particular embodiments, pump 106 is a liquid propane pump.

In particular embodiments, additional pipes, such as liquid bypass pipe 112 and vapor return pipe 114, may be coupled to tank 102. The other end of liquid bypass pipe 112 may be coupled to liquid supply pipe 110 between pump 106 and dispenser 104 to provide liquid recirculation. The other end of vapor return pipe 114 may be coupled to dispenser 104 to return vapor from dispenser 104 to tank 102.

Skid 108 is a mounting structure for components of autogas dispensing system 100 such as tank 102, dispenser 104, and pump 106. Autogas dispensing system 100 may be easily transported as a unit when all major components are mounted to skid 108. Additionally, skid 108 may provide support and protection for piping, such as liquid supply pipe 110, liquid bypass pipe 112, and vapor return pipe 114, and for various electrical components and connections (not illustrated).

In an example of operation of a particular embodiment, an autogas propane powered vehicle operator may stop to refuel the vehicle at autogas dispensing system 100. The operator may connect a hose end valve of dispenser 104 to a vehicle filler valve coupled to the vehicle's autogas propane storage tank. The operator may activate dispenser 104 by a lever activated handle coupled to the hose end valve. Upon activation of dispenser 104, pump 106 may deliver liquid propane through liquid supply pipe 110 to dispenser 104 and to the operator's vehicle. Liquid bypass pipe 112 may return any excess liquid back to tank 102. Vapor return pipe 114 may return any vapor from dispenser 104 to tank 102.

In particular embodiments, autogas dispensing system 100 may dispense liquids that may be flammable or volatile under certain conditions. National, state, and local codes may specify safety measures for installation of autogas dispensing system 100 at locations such as service stations, truck stops, fleet-maintenance facilities, or propane sales outlets. For example, safety measures may include installation of concrete post barriers to prevent a vehicle from contacting components of autogas dispensing system 100. Protecting components of autogas dispensing system 100 from vehicle contact or other undesirable contact is thus an advantageous safety feature.

FIG. 2A is a cross-sectional side view of an autogas dispensing tank, in accordance with particular embodiments. FIG. 2A illustrates tank 202, similar to tank 102 described above in reference to FIG. 1.

Tank 202 comprises liquid supply orifice 210, vapor orifices 212 and 220, liquid bypass orifice 214, vapor conduits 216 and 218, liquid withdrawal orifice 222, and diptube 224. In particular embodiments, tank 202 may comprise a 1,000 water gallon tank, or any size tank suitable for dispensing autogas propane.

The contents of tank 202 comprise a liquid phase commodity 226 located in a bottom portion of tank 202 and a gaseous vapor phase commodity 228 located above liquid commodity 226 in an upper portion of tank 202. The ASME, as well as national, state, and local agencies, publish rules and specifications regarding the maximum percentage of tank 202 that liquid phase commodity 226 may occupy. In particular embodiments, liquid phase commodity 226 comprises liquid propane and vapor phase commodity 228 comprises propane vapor. In particular embodiments, regulations may limit liquid phase commodity 226 to no more than 80% of tank 202 capacity.

Liquid supply orifice 210 facilitates transfer of liquid phase commodity 226 out of tank 202. In particular embodiments, liquid supply orifice 210 may comprise a 2 inch 3000# or 6000# half coupling. In some embodiments, liquid supply orifice 210 may be greater than 2 inches in diameter. In particular embodiments, liquid supply orifice 210 may comprise any size or style coupling suitable for transferring liquid phase commodity 226 out of tank 202.

Traditional above ground propane tanks comprise a liquid supply opening 1.25 inches in diameter. A liquid supply opening of 1.25 inches may not supply sufficient liquid flow to a high capacity pump, such as pump 106. A particular advantage of the current disclosure, according to particular embodiments, is that approximately 2 inch diameter liquid supply orifice 210 may supply sufficient liquid flow to a high capacity pump, such as pump 106, which thereby decreases the time for refueling vehicles with large fuel storage tanks.

Locating liquid supply orifice 210 on a bottom portion of tank 202 has particular advantages. For example, piping coupled to liquid supply orifice 210, such as liquid supply pipe 110, may be routed underneath tank 202 near the ground and protected by skid 108.

Additionally, particular embodiments that locate liquid supply orifice 210 at a position on tank 202 farther away from pump 106 increase the length of liquid supply pipe 110 between liquid supply orifice and pump 106. Longer lengths of liquid supply pipe 110 may allow for greater dissipation of air bubbles. Thus, liquid supply pipe 110 that is protected by skid 108 may be longer without increasing risk of damage to liquid supply pipe 110.

Vapor orifice 212 facilitates transfer of vapor phase commodity 228 into tank 202. In particular embodiments, vapor orifice 212 may comprise a 1.25 inch 3000# or 6000# half coupling. In particular embodiments, vapor orifice 212 may comprise any size or style coupling suitable for transferring vapor phase commodity 228 into tank 202.

Vapor conduit 216 is coupled to vapor orifice 212 and extends into the vapor space of tank 202 (the space occupied by vapor phase commodity 228). In particular embodiments, one end of vapor conduit 216 may be welded to vapor orifice 212. In particular embodiments, vapor conduit 216 allows vapor orifice 212 located on a bottom portion of tank 202 to be in communication with the vapor space of tank 202.

Locating vapor orifice 212 on a bottom portion of tank 202 has particular advantages. For example, piping coupled to vapor orifice 212, such as vapor return pipe 112, may be routed underneath tank 202 near the ground and protected by skid 108.

Liquid bypass orifice 214 facilitates transfer of liquid phase commodity 226 into tank 202. In particular embodiments, liquid bypass orifice 214 may comprise a 1.25 inch 3000# or 6000# half coupling. In particular embodiments, liquid bypass orifice 214 may comprise any size or style coupling suitable for transferring liquid phase commodity 226 into tank 202.

Vapor conduit 218 is coupled to liquid bypass orifice 214 and extends into the vapor space of tank 202. In particular embodiments, one end of vapor conduit 218 may be welded to liquid bypass orifice 214. In particular embodiments, vapor conduit 218 allows liquid bypass orifice 214 located on a bottom portion of tank 202 to be in communication with the vapor space of tank 202.

Locating liquid bypass orifice 214 on a bottom portion of tank 202 has particular advantages. For example, piping coupled to liquid bypass orifice 214, such as liquid bypass pipe 114, may be routed underneath tank 202 near the ground and protected by skid 108.

In particular embodiments, vapor orifice 220 facilitates transfer of vapor phase commodity 228 into tank 202. Vapor orifice 220 may be located on a top portion of tank 202 and may be in direct communication with the vapor space of tank 202.

In particular embodiments, liquid withdrawal orifice 222 facilitates removal of liquid phase commodity 226 from tank 202. Liquid withdrawal orifice 222 may be located on a top portion of tank 202 and may be coupled to one end of diptube 224. The other end of diptube 224 extends into the liquid space and near a bottom portion of tank 202. Liquid phase commodity 226 may be withdrawn from tank 202 through diptube 224 and liquid withdrawal orifice 222. For example, a propane service company may drain tank 202 by connecting a drain hose to liquid withdrawal orifice 222 and pumping the contents of tank 202 into a propane service truck.

Particular embodiments of the present disclosure offer advantages over using traditional above ground propane tanks in an autogas dispensing system. For example, an autogas dispensing system using a traditional above ground propane tank may route vapor return pipe 114 from a coupling on a lower portion of dispenser 104 to vapor orifice 220. Such a routing of vapor return pipe 114 requires bends and connectors to reach from the lower portion of dispenser 104 to vapor orifice 220 located on an upper portion of tank 202. Additionally, such a route above or beside tank 202 exposes vapor return pipe 114 to additional risk of damage from unwanted contact with vehicles or other external elements.

Similarly, an autogas dispensing system using a traditional above ground propane tank may route liquid bypass pipe 112 from a coupling near pump 106, which may usually be near ground level, to liquid withdrawal orifice 222 located on a top portion of tank 202. Such a routing above or beside tank 202 requires extra bends and connectors compared to a more direct route and exposes liquid bypass pipe 112 to risk of damage. Additionally, when liquid bypass pipe 112 is coupled to liquid withdrawal orifice 222, pump 106 is pumping the recirculated liquid into the liquid space of tank 202. Pumping the recirculated liquid into the liquid space of tank 202 creates more back pressure on pump 106 than if pump 106 pumped the recirculated liquid into the vapor space of tank 202.

Locating vapor orifice 212 and liquid bypass orifice 214 on a bottom portion of tank 202 facilitates a more direct routing of piping from orifices 212 and 214 on one end and the bottom portion of dispenser 104 or pump 106 on the other end. The piping may be routed underneath tank 202 near the ground and protected by skid 108. Additionally, liquid bypass orifice 214 may be in communication with the vapor space of tank 202 via vapor conduit 218. Thus, pump 106 pumping recirculated liquid into the vapor space of tank 202 through liquid bypass orifice 214 may experience less back pressure than pumping recirculated liquid into the liquid space of tank 202 through liquid withdrawal orifice 222.

FIG. 2B is a cross-sectional end view of an autogas dispensing tank, in accordance with particular embodiments. FIG. 2B illustrates tank 202, liquid supply orifice 210, vapor orifice 212, liquid bypass orifice 214, and vapor conduits 216 and 218, similar to like numbered elements described above in reference to FIGS. 1 and 2A.

In particular embodiments, liquid supply orifice 210 may be located on a bottom portion of tank 202 on centerline 230. Vapor orifice 212 may be located on a bottom portion of tank 202 and to the right of centerline 230. Liquid bypass orifice 214 may be located on a bottom portion of tank 202 and to the left of centerline 230. Such a configuration may reduce interference between piping coupled to orifices 210, 212, and 214.

Although embodiments of the present disclosure and their advantages have been described in detail, it should be understood that various changes, substitutions and alterations can be made herein without departing from the spirit and scope of the invention as defined by the following claims. For example, although the figures illustrate various locations of orifices 210, 212, and 214 with respect to each other and the bottom portion of tank 202, various embodiments contemplate flexibility in the configuration of the various orifices with respect to each other and the bottom portion of tank 202. Additionally, while the disclosure describes certain embodiments with respect to an autogas propane dispensing system, particular embodiments may be used for a variety of liquid dispensing systems.

Other advantages of particular embodiments include retrofitting existing above ground propane tanks with the orifices, conduits, and fittings described herein.

What is claimed is:

1. A liquid storage tank, comprising:
a pressure chamber comprising a liquid space located at a bottom interior portion of the pressure chamber and a vapor space located at a top interior portion of the pressure chamber;
a first orifice located in a bottom portion wall of the pressure chamber; and
a first vapor conduit coupled to the first orifice and extending into the vapor space of the pressure chamber forming a passageway between the first orifice and the vapor space of the pressure chamber.

2. The tank of claim 1, further comprising:
a second orifice located in the bottom portion wall of the pressure chamber; and
a second vapor conduit coupled to the second orifice and extending into the vapor space of the pressure chamber forming a passageway between the second orifice and the vapor space of the pressure chamber.

3. The tank of claim 2, wherein:
the first orifice is offset from a longitudinal centerline of the bottom of the pressure chamber; and
the second orifice is offset from the longitudinal centerline of the bottom of the pressure chamber and offset in a direction opposite the offset of the first orifice.

4. The tank of claim 2, further comprising:
a third orifice of equal to or greater than approximately two inches diameter located in the bottom portion wall of the pressure chamber.

5. The tank of claim 4, wherein:
the first orifice is offset from a longitudinal centerline of the bottom of the pressure chamber;
the second orifice is offset from the longitudinal centerline of the bottom of the pressure chamber and offset in a direction opposite the offset of the first orifice; and
the third orifice is located along the longitudinal centerline of the bottom of the pressure chamber.

6. The tank of claim 1, wherein the first orifice is offset from a longitudinal centerline of the bottom of the pressure chamber.

7. The tank of claim 1, wherein the liquid is propane.

8. A liquid dispensing system, comprising:
a liquid storage tank, comprising:
a pressure chamber comprising a liquid space located at a bottom interior portion of the pressure chamber and a vapor space located at a top interior portion of the pressure chamber;
a first orifice located in a bottom portion wall of the pressure chamber;
a first vapor conduit coupled to the first orifice and extending into the vapor space of the pressure chamber forming a passageway between the first orifice and the vapor space of the pressure chamber;
a second orifice located in the bottom portion wall of the pressure chamber;
a second vapor conduit coupled to the second orifice and extending into the vapor space of the pressure chamber forming a passageway between the second orifice and the vapor space of the pressure chamber; and
a third orifice of equal to or greater than approximately two inches diameter located in the bottom portion wall of the pressure chamber;
a liquid dispenser configured to dispense liquid into an external storage tank; and
wherein:
the third orifice is coupled, by a liquid supply pipe, to a liquid supply inlet port of the liquid dispenser;
the second orifice is coupled to a liquid bypass port of the liquid supply pipe; and
the first orifice is coupled to a vapor release port of the liquid dispenser.

9. The liquid dispensing system of claim 8, wherein:
the first orifice is offset from a longitudinal centerline of the bottom of the pressure chamber;
the second orifice is offset from the longitudinal centerline of the bottom of the pressure chamber and offset in a direction opposite the offset of the first orifice; and
the third orifice is located along the longitudinal centerline of the bottom of the pressure chamber.

10. The liquid dispensing system of claim 8, wherein the liquid supply pipe is positioned below the liquid storage tank.

11. The liquid dispensing system of claim 8, wherein the first orifice is coupled to a vapor release port of the liquid dispenser by a vapor release pipe.

12. The liquid dispensing system of claim 11, wherein the vapor release pipe is positioned below the liquid storage tank.

13. The liquid dispensing system of claim 8, wherein the liquid is propane.

14. The liquid dispensing system of claim 13, wherein the liquid dispenser is a high capacity propane pump.

15. A method for dispensing liquid, comprising:
pumping a liquid from a liquid storage tank to a liquid dispenser configured to dispense liquid into an external storage tank, wherein:
the liquid storage tank comprises:
a pressure chamber comprising a liquid space located at a bottom interior portion of the pressure chamber and a vapor space located at a top interior portion of the pressure chamber;
a first orifice located in the bottom portion wall of the pressure chamber; and
a first vapor conduit coupled to the first orifice and extending into the vapor space of the pressure chamber forming a passageway between the first orifice and the vapor space of the pressure chamber.

16. The method of claim 15, wherein the liquid storage tank further comprises:
a second orifice located in the bottom portion wall of the pressure chamber; and
a second vapor conduit coupled to the second orifice and extending into the vapor space of the pressure chamber forming a passageway between the second orifice and the vapor space of the pressure chamber.

17. The method of claim 16, wherein:
the first orifice is offset from a longitudinal centerline of the bottom of the pressure chamber; and
the second orifice is offset from the longitudinal centerline of the bottom of the pressure chamber and offset in a direction opposite the offset of the first orifice.

18. The method of claim 16, wherein the liquid storage tank further comprises a third orifice of equal to or greater than approximately two inches diameter located in the bottom portion wall of the pressure chamber.

19. The method of claim 18, wherein:
the first orifice is offset from a longitudinal centerline of the bottom of the pressure chamber;
the second orifice is offset from the longitudinal centerline of the bottom of the pressure chamber and offset in a direction opposite the offset of the first orifice; and
the third orifice is located along a longitudinal centerline of the bottom of the pressure chamber.

20. The method of claim 15, wherein the first orifice is offset from a longitudinal centerline of the bottom of the pressure chamber.
